(19) United States
(12) Patent Application Publication
(10) Pub. No.: US 2026/0266769 A1
(43) Pub. Date: Sep. 10, 2026

(54) Acoustic Inspection Method and Apparatus Therefor

(71) Applicant: ICR Integrity Ltd, Aberdeen (GB)

(72) Inventor: Sam SMEETON, Sheffield (GB)

(21) Appl. No.: 18/876,354

(22) PCT Filed: Jun. 22, 2023
(86) PCT No.: PCT/GB2023/051644

§ 371 Date: Dec. 18, 2024

(30) Foreign Application Priority Data
Jun. 23, 2022 (GB) 2209240.7

(51) Int. Cl. G01N 29/12; G01N 29/22; G01N 29/24; G01N 29/265; G01N 29/34

(52) U.S. Cl. CPC G01N 29/12; G01N 29/228; G01N 29/2487; G01N 29/265; G01N 29/348; G01N 2291/0231; G01N 2291/0234; G01N 2291/102; G01N 2291/105; G01N 2291/2634

(57) ABSTRACT

The invention provides a method and apparatus for acoustically inspecting a composite repair on a metal structure, the composite repair comprising at least one layer of a composite material applied to a metal substrate of the structure in a repair zone. The method comprises exciting the composite repair within the repair zone using a broadband acoustic excitation signal, and receiving and analysing acoustic data from the first acoustic scan to determine at least one approximate location of one or more defects in the repair zone. In a second acoustic scan, the composite repair is excited in the at least one approximate location using an acoustic excitation signal with frequency characteristics selected to excite the composite material in preference to the metal substrate, and receiving and analysing acoustic data from the second acoustic scan to enable the one or more defects to be characterised as being present in the least one layer of a composite material or present in the metal substrate. In an aspect of the invention, an acoustic probe assembly comprises a housing and first and second acoustic transducer subassemblies arranged in the housing. The first and second acoustic transducer subassemblies are configured to enable operation as a transmitter and a receiver respectively, and each of the transducer subassemblies is elongated along a respective axis of orientation, has a first end configured to contact against a material to be inspected, and is axially movable within a respective bore of the housing. The first ends of the first and second transducer subassemblies are biased towards an extended position in a direction towards the first ends; and the axes of the first and second transducers are inclined towards one another.

### BACKGROUND TO THE INVENTION

The present invention relates to the field of acoustic inspection, and in particular to a method and apparatus for acoustic inspection of composite repairs of metal structures, pressure vessels, pipework and pipelines.

Over recent years, composite repairs, made of materials such as glass fibre reinforced polymer (GFRP) and carbon fibre reinforced polymer (CFRP), have been increasingly used as a means of repairing impaired pressure containment vessels, pipes, and other load bearing structures within the oil and gas sector. Although these repairs have brought benefits in terms of improved integrity and reduced downtime, there have also been some instances of failure in these repairs. Such failures have been attributed to factors including poor installation practices, inadequate design and use in unsuitable applications.

Due to the load-bearing requirements of vessels, pipework, and other structures, a good bond between the installed composite repair and the metal is critical in ensuring sufficient transfer of loads and a successful repair. Accordingly, bonding defects at the composite-metal interface, such as kissing bonds, can be detrimental to the longevity of these repairs. In addition, defects in either the composite repair or the metal structure, such as volumetric flaws, can also be contributing factors to repair failure. As such, within the oil and gas sector there is a need for in-service inspection systems which can inspect and monitor the structural integrity of composite repairs applied to metal structures, providing early cues to potential failures.

Several commercial ultrasonic inspection techniques already exist which go some way towards solving this problem. However, all of them are considered to have limitations of some kind, impacting their industrial applicability. Such limitations may include their sensitivity to defects and flaws of small dimensions, their ability to be applied to a wide range of geometries, and their ability to be applied to the inspection of composite repairs.

US2018106765 describes a handheld ultrasonic inspection probe used for determining the bond quality between a thermal protection system material and a composite. Although this technique is said to be able to reveal possible unbonds or kissing bonds, the nature of the probe design means it is only applicable where the substrate surface being scanned is relatively flat.

US2022003714 relates to a handheld device which can scan surfaces of composite materials exhibiting varying surface profiles, to detect sub-surface material defects. The device includes a number of differently shaped attachments which fit onto the ultrasound probe enabling conformal contact between the probe and a variety of surface morphologies. Although this method goes part way towards addressing the issue of scanning irregularly shaped surfaces it is only applicable to very specific surface geometries.

US2018003680 describes a method for inspecting coated plates and pipes, using an electromagnetic acoustic transducer (EMAT) based inline inspection (ILI) tool. Using this inspection tool, optimum operating frequencies are determined at roughly 325 kHz and 425 kHz. During inspection, the structure is initially excited using broadband ultrasonic guided waves. One or more narrow frequency bands are then selected based on this acquired data, and the structure is then inspected using ultrasonic guided waves in these narrow frequency bands. By identifying these narrow frequency bands, US2018003680 describes that particular layers in the structure can essentially be ignored during inspection.

U.S. Pat. No. 4,509,369 uses the concept of focussing an ultrasonic beam to increase the sensitivity in detecting near-surface flaws. The probes are angled to better detect near-surface flaws and their depth in pressure vessels, specifically between carbon steel and an inner cladding of stainless steel.

These known methods attempt to solve different issues associated with the identification of defects within composite materials. However, none of them fully address the issues present in the inspection of composite repairs within oil and gas pipelines, pressure containing vessels, and other structures. In particular, they lack the ability to detect the nature and depth of the defects at a sufficient level of detail, in situations where the pipes have irregular and complex geometries.

Sonomatic has developed an inspection technology marketed as Dynamic Response Spectroscopy (DRS), which can be used for the inspection of repairs on pipes. This technology relies on a tracker system which keeps the transducer at a precise angle and distance from the repair. As a consequence, the technology can only be used on repairs applied to straight pipe segments.

U.S. Pat. No. 6,234,025 uses the concept of focussing an ultrasonic beam to increase the sensitivity in detecting near-surface flaws. A lens is used to focus an ultrasound beam in an area of interest, enabling imaging of disbonds and delaminations between repair patches and aircraft parts.

The Sonomatic system and the apparatus of U.S. Pat. No. 6,234,025 both lack the ability to detect the nature and depth of the defects at a sufficient level of detail, in situations where irregular and complex geometries are present.

### SUMMARY OF THE INVENTION

According to a first aspect of the invention, there is provided a method of acoustically inspecting a composite repair on a metal structure, the composite repair comprising at least one layer of a composite material applied to a metal substrate of the structure in a repair zone, wherein the method comprises:
in a first acoustic scan, exciting the composite repair within the repair zone using a broadband acoustic excitation signal, and receiving and analysing acoustic data from the first acoustic scan to determine at least one approximate location of one or more defects in the repair zone;
in a second acoustic scan, exciting the composite repair in the at least one approximate location using an acoustic excitation signal with frequency characteristics selected to excite the composite material in preference to the metal substrate, and receiving and analysing acoustic data from the second acoustic scan to enable the one or more defects to be characterised as being present in the least one layer of a composite material or present in the metal substrate.

The broadband acoustic excitation signal may comprise multiple frequencies in the range of 1 kHz to 100 kHz. In a preferred embodiment, the broadband acoustic excitation pulse may comprise multiple frequencies in the range of 5 kHz to 50 kHz, and may comprise a spread of frequencies across that range. The inventor has appreciated that such frequency ranges are effective for the inspection of composite repairs.

In the second acoustic scan, characterising the one or more defects as being present in the least one layer of the composite material may include characterising a defect as being internal to the composite material or being present at the interface of the composite layer and the metal substrate (i.e. “in at least one layer of the composite material” is intended to include “at the interface between the composite layer and the metal substrate”).

The metal substrate may for example be a metal wall of a pressure vessel, such as a pipeline wall, or may be a metal wall or component of another load bearing structure.

The second acoustic scan may have an acoustic excitation signal with a frequency in the range of 10 kHz to 25 kHz. In another embodiment, the second acoustic scan may have an acoustic excitation signal with a frequency in the range of 15 kHz to 20 kHz. In a preferred embodiment, the second acoustic scan may have an acoustic excitation signal with a frequency of approximately 17 kHz (i.e. in the range 17 kHz+/−0.5 kHz).

The method may comprise utilising an acoustic probe assembly comprising a transmitter transducer and a receiver transducer. The method may comprise utilising a pitch and catch acoustic method. The method may comprise manually operating an acoustic probe assembly.

The method may comprise determining an approximate location of a defect using a first acoustic probe assembly having wide field of view characteristics. The method may comprise determining a location of a defect previously approximately located using a second acoustic probe assembly having high spatial resolution characteristics.

The method may comprise sizing an identified defect. Sizing the identified defect may comprise determining an excitation frequency at which the defect gives a maximum signal response, and determining the extremities of the defect using a half amplitude analysis method.

The method may comprise detecting a defect that has a dimension in a direction parallel to the surface of the composite repair of less than 50 mm. The method may comprise detecting a defect that has a dimension in a direction parallel to the surface of the composite repair of less than 30 mm. The method may comprise detecting a defect that has a dimension in a direction parallel to the surface of the composite repair of less than 20 mm. The method may comprise detecting a defect that has a dimension in a direction parallel to the surface of the composite repair of approximately 15 mm.

The method may comprise detecting a defect that has a dimension in a direction normal to the surface of the composite repair of less than 0.5 mm. The method may comprise detecting a defect that has a dimension in a direction normal to the surface of the composite repair of less than 0.1 mm. The method may comprise detecting a defect that has a dimension in a direction normal to the surface of the composite repair of approximately 0.05 mm. This facilitates detection of kissing bonds and/or intra-layer delaminations that have a much smaller dimension than those capable of being detected using conventional techniques. This is particularly important for in-service inspection methods, in which structures, vessels and/or pipelines being inspected may be at elevated temperatures. At elevated operating temperatures, thermally induced expansion of metal substrates may reduce the effective size of kissing bond defects to the point that they are not detectable using less sensitive systems. An increased sensitivity to defect thickness in a direction normal to the repair surface enables detection of smaller kissing bond defects, and/or kissing bond defects that have been temporarily reduced in apparent thickness due to the thermal conditions. This may be of particular importance in the inspection of composite repairs on metal walls of pipelines in the oil and gas sector, which are commonly used to carry fluids at elevated temperature.

The method may comprise characterising a depth of a defect in a direction normal to the surface of the composite repair. Characterising the depth may comprise comparing an acoustic response with an acoustic response of one or more reference samples having defects of known depths. The method may comprise utilising a resonance probe method to characterise a depth of a defect. The method may comprise utilising an MIA probe method to characterise a depth of a defect.

The method may comprise manually manoeuvring the probe assembly in relation to the structure.

The method may comprise carrying out acoustic inspection whilst the structure is at an elevated temperature above an ambient temperature.

The method may comprise acoustic inspection, wherein the structure comprises a substrate of steel or a steel alloy, and the composite material forms at least a part of a composite repair applied to the substrate. The structure may comprise a pipeline, pipework or a pressure containing vessel.

In an alternative embodiment, the structure may comprise a substrate of an alloy of nickel and copper, or Monel® alloys, and the composite material forms at least part of a composite repair applied to the substrate.

According to a second aspect of the invention, there is provided an apparatus for acoustically inspecting a structure comprising a composite material, the apparatus comprising:
a probe assembly comprising a housing and first and second acoustic transducer subassemblies arranged in the housing;
wherein the first and second acoustic transducer subassemblies are configured to enable operation as a transmitter and a receiver respectively;
wherein each of the transducer subassemblies is elongated along a respective axis of orientation, has a first end configured to contact against a material to be inspected, and is axially movable within a respective bore of the housing;
wherein the first ends of the first and second transducer subassemblies are biased towards an extended position in a direction towards the first ends;
and wherein the axes of the first and second transducer subassemblies are inclined towards one another.

The axes of the first and second transducer subassemblies are inclined towards one another in a direction towards the first ends. The axes may converge at a point extending from the first ends.

The angle between the axes of the two transducer subassemblies may be in the range of 10 degrees to 170 degrees. In another embodiment, the angle between the axes of the two transducer subassemblies may be in the range of 30 degrees to 90 degrees. In a preferred embodiment, the angle between the axes of the two transducer subassemblies may be 60 degrees.

The housing may have a housing axis which in normal use is substantially perpendicular to a surface of the material to be inspected.

An angle between the axis of the first transducer subassembly and the housing axis may be approximately equal to an angle between the axis of the second transducer subassembly and the housing axis. That is, the respective axes of the first and second transducer assemblies may be oriented symmetrically about the housing axis.

In an alternative embodiment, the angles between the respective axes of the first and second transducer subassemblies may be different from one another, and the respective axes of the first and second transducer assemblies may be oriented asymmetrically about the housing axis.

The axis of the first transducer subassembly or the axis of the second transducer subassembly may be substantially parallel to the housing axis.

When the first and second transducer subassemblies are in their retracted positions, the distance between the first ends of the first and second transducer subassemblies may be in the range of 2 mm to 12 mm. In another embodiment, when in this retracted position, the distance between the first ends of the first and second transducer subassemblies may be in the range of 5 mm to 9 mm. In a preferred embodiment, when in this retracted position, the distance between the first ends of the first and second transducer subassemblies may be 7 mm.

The housing may be manufactured from a low friction material. In a preferred embodiment the housing may be manufactured from a polytetrafluoroethylene (PTFE)-based material.

The apparatus may comprise two or more wear pin elements, which may be provided on the probe housing. The wear pins may provide a limit to the force that can be applied to the first ends of the first and second transducer subassemblies when contacting with the material to be inspected.

The apparatus may comprise a biasing means which biases the first and second transducer subassemblies towards an extended position. At the retracted position, the biasing means may exert a force component on each respective transducer subassemblies in the range of 0.4 N to 1.5 N, measured on an axis bisecting the angle between the transducer subassembly axes. In other words, a force on the probe assembly in the range of 0.8 N to 3 N is required to act against the biasing means to retract both transducer subassemblies to the retracted position, and the perpendicular force component from each respective transducer subassemblies acting on the inspection surface is in the range of 0.4 N to 1.5 N. Preferably, the same force is in the range of 0.7 N to 1.1 N, and may be approximately 0.9 N. The retracted position may be a position at which the wear pins (if present) are in contact with a surface of the material to be inspected.

The biasing means may comprise a spring which maintains the first and second transducer subassemblies biased towards an extended position within their respective bores. The biasing means may comprise a pair of springs, each acting on a respective transducer subassembly. Each spring may have a spring constant in the range of 0.15 N/mm (150 Nm⁻¹) to 0.25 N/mm (250 Nm⁻¹). In a preferred embodiment this spring constant may be approximately 0.2 N/mm (200 Nm⁻¹).

Embodiments of the second aspect of the invention may include one or more features of the first aspect of the invention or its embodiments, or vice versa.

According to a third aspect of the invention, there is provided a method of acoustically inspecting a structure comprising a composite material, the method comprising using the apparatus of the second aspect of the invention.

The method may comprise carrying out an acoustic scan of the structure by manually manoeuvring the probe assembly in relation to the structure.

The method may comprise carrying out acoustic inspection whilst the structure is at an elevated temperature above an ambient temperature.

The structure comprises a substrate of steel or a steel alloy, and the composite material may form at least a part of a composite repair applied to the substrate. The structure may comprise a pipeline, pipework or a pressure containing vessel.

In an alternative embodiment, the structure may comprise a substrate of an alloy of nickel and copper, or Monel® alloys, and the composite material may form at least part of a composite repair applied to the substrate.

Embodiments of the third aspect of the invention may include one or more features of the first or second aspects of the invention or their embodiments, or vice versa.

### BRIEF DESCRIPTION OF THE DRAWINGS

There will now be described, by way of example only, embodiments of the invention with reference to the following drawings, of which:

FIG. 1A is a schematic representation of an acoustic inspection system according to an embodiment of the invention;

FIG. 1B is an enlarged sectional view a composite repair in the system of FIG. 1A;

FIG. 2 is a schematic representation of a method of acoustically inspecting a composite repair on a pipeline according to an embodiment of the invention.

FIGS. 3A and 3B are schematic representations of an acoustic probe assembly used with an embodiment of the invention;

FIGS. 4A to 4C are schematic representations of an alternative acoustic probe assembly according to an embodiment of the invention;

FIG. 5 is a schematic representation of additional method steps that may be used with the method of FIG. 2;

FIG. 6 is a schematic representation of additional method steps that may be used with the method of FIG. 2;

FIG. 7 is a schematic representation of additional method steps that may be used with the method of FIG. 2;

FIG. 8 is a schematic representation of a method of acoustically inspecting a composite repair according to a particular embodiment.

### DETAILED DESCRIPTION OF PREFERRED EMBODIMENTS

Embodiments of the invention will be described in the context of the inspection of composite repairs on pipework, by way of example only, and it will be appreciated that the invention in at least some of its aspects is applicable to the inspection of composite repairs on other kinds of load-bearing structures, including pressure vessels and pipelines formed from a metal substrate, and in particular structures formed from steel or alloys of steel, including but not limited to mild steel, stainless steel, super duplex steel, duplex steel and cunifer.

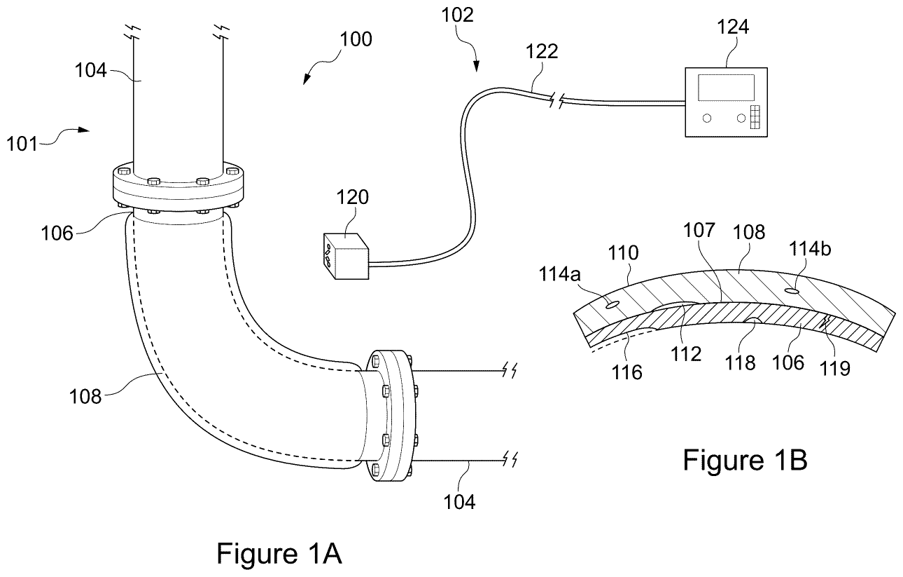

Referring firstly to FIGS. 1A and 1B, there is shown a system 100 comprising a pipeline 101 and an acoustic inspection system 102. The pipeline is formed from multiple sections, including linear pipe joints 104 and an elbow joint 106 connected to the linear joints 104 by flanges. The pipe joints and elbow joint are formed from a steel alloy selected according to the operating conditions of the pipeline, and define a pipe wall.

The elbow joint 106 has been subject to a composite repair, according to techniques known in the industry, and has a laminated structure 108 formed from multiple layers of composite material applied around the steel of the elbow joint 106. The composite material is applied in a repair zone and maintains and/or re-establishes the pressure bearing capability of the pipe at the elbow joint 106. The structure 108 follows the geometry of the elbow joint, which in this case is a 90 degree elbow.

The acoustic inspection system 102 comprises a probe assembly 120 connected to a control unit 124 by a cable 122. The probe assembly 120 is manually operable and manoeuvrable in relation to the inspection target, and as such can be readily positioned with respect to parts of the inspection target required to be inspected in a range of orientations, without a requirement for a specific mounting or tracking systems that define the probe-target geometry. This makes the probe suitable for targets with a wide range of shapes and geometries (including the elbow joint shown in the example). The probe assembly 120 is a “pitch and catch” probe assembly, comprising a transmitter acoustic transducer subassembly and a receiver acoustic transducer subassembly, as will be described in more detail below.

A perceived drawback of using composite repair techniques on a metal base pipe or other metal substrate is that inspection methods typically used in the industry to inspect the integrity of the pipes are not applicable, or at least have limited applicability. Defects and flaws in the substrate materials may be more difficult to detect due the material in the repair zone not being directly accessible by inspection instruments. In addition, the composite repair structure itself may have defects or flaws within the structure of the composite material (e.g. between laminations) and/or at the composite-metal interface, such as kissing bond defects.

FIG. 1B is a schematic cross section through a part of the elbow joint 106 in the repair zone, showing representative defects in the steel wall of the joint 106 and in the composite material structure 108. In the representation of FIG. 1B, the repaired elbow joint comprises a kissing bond defect 112 (or unbonding/delamination of the composite and the substrate), composite material internal defects 114a and 114b, a wall thickness loss defect 116 on the internal surface of the joint, a surface pitted defect 118, and a crack 119. In the context of this specification, defects or flaws outside of the outer surface 107 of the wall of the elbow joint (or other substrates where applicable) are considered to be “in the composite”, whereas defects inside of the outer surface of the wall are considered to be “in the wall”. Defects 112, 114a, and 114b are therefore characterised as in the composite material, whereas defects 116, 118 and 119 are considered to be in the wall. It is a feature of aspects of the invention that such defects can be located and characterised as being in the composite structure or in the wall, as will be described below.

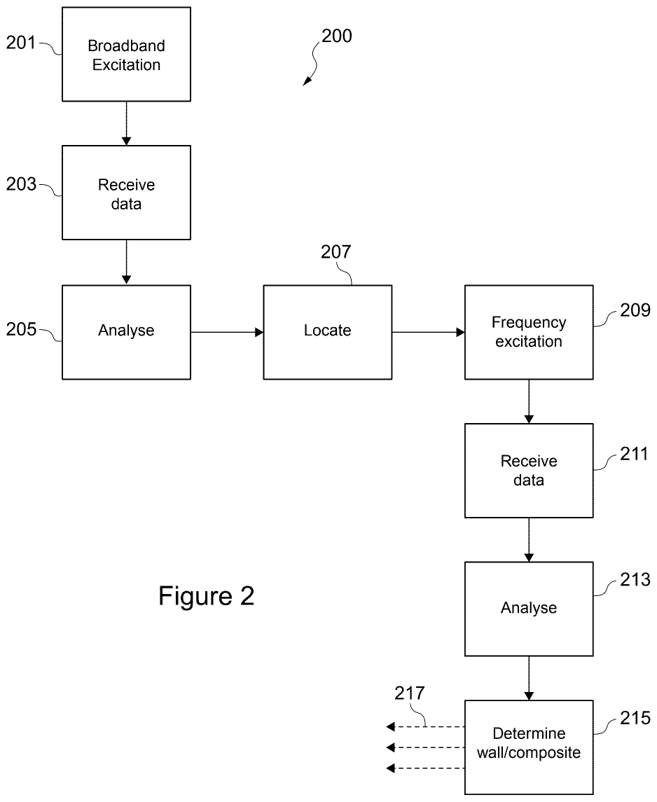

FIG. 2 is a schematic representation of a method of acoustically inspecting a composite repair on a pipeline according to an embodiment of the invention. The method, generally shown at 200, comprises a first step 201 of carrying out a first acoustic scan by exciting the pipeline in a repair zone using a broadband acoustic pulse from the probe assembly 120, by placing the probe assembly into physical contact with an outer surface of the composite structure 108, and moving the probe assembly over the surface. The frequency and amplitude characteristics of the broadband acoustic pulse are set by the control unit 124, and in a preferred embodiment of the invention, the pulse is a low frequency broadband acoustic pulse with frequencies from 5 kHz to 50 kHz. Other low frequency broadband acoustic pulses may be used in other preferred embodiments of the invention, for example with frequencies between 1 kHz to 100 kHz. In general, the inventor has identified that acoustic pulses with frequencies below 100 kHz, and preferably below 50 kHz, are most suitable for the inspection of composite repairs.

The probe assembly 120 of this embodiment is a “pitch and catch” probe assembly, comprising a transmitter acoustic transducer subassembly and a receiver acoustic transducer subassembly. The acoustic data from the excited inspection area is received by the probe assembly (step 203) and transmitted to the control unit 124. The control unit 124 comprises a display element which displays information to the operator of the probe assembly in real time, facilitating the scanning operation.

Analysis of the received data (step 205) is carried out, at least in part, by the operator of the probe in as the scan is performed. Alternatively, or in addition, data received by the probe is transmitted to a connected data analysis module, which may be for example a computer running suitable data analysis software. Optionally the data are digitally recorded, and may be processed and/or analysed by the data analysis module to assist, enhance or replace real-time analysis performed by the operator.

A purpose of the analysis is to locate, at least approximately, the position of one or more defects in the composite repair. The defects may include (without limitation) kissing bond defects (or unbonding/delamination of the composite and the substrate), composite material internal defects, wall thickness loss defects on the internal surface of the joint, surface pitted defects, and/or cracks. Through assessment of acoustic waveform responses by the operator or by analysis software (or a combination of the two), the presence of a defect is identified and its location or approximate location over the surface of the repair zone is recorded (step 207). Using this approach, defects can be located with an accuracy of around +/−20 mm, in a direction parallel to the surface of the composite repair. Recording the location may be facilitated by applying a grid pattern to the surface of the repair zone and recording a corresponding grid reference, using x and y co-ordinates where the x axis is the longitudinal direction of the pipe, and the y axis is a circumferential direction around the pipe.

Although the first broadband scan enables location of a defect over the surface of the repair zone in the x-y directions, in most cases it is not possible to determine where the defect is in a z-axis, corresponding to a radial depth below the surface in the combined volume of composite material and substrate. The method includes a second acoustic scan at a frequency or frequencies selected to excite the composite material in preference to the excitation of the substrate. In many typical pressure vessel applications, where the substrate is formed from a steel-based material, it has been observed by the inventor that an acoustic pulse of approximately 17 kHz does not excite a steel material sufficiently to be sensitive to defects located in the substrate. For example, a scan with an acoustic pulse of 17 kHz would not detect the defects 116, 118 or 119 of FIG. 1B, but would detect defects 112, 114a and 114b in the composite structure.

Applying this phenomenon in the method, a second acoustic scan excites the composite repair at a frequency of 17 kHz (step 209), in the previously determined x-y location or approximate location from step 207. Acoustic data is received (211) from the excited composite material and is analysed (213). Through assessment of acoustic waveform responses by the operator or by analysis software (or a combination of the two), an approximate location in the z-direction can be determined. If the presence of a defect is identified, it can be noted that there is a defect present in the composite material (including being a kissing bond defect or unbonding between the composite and the substrate at interface 107). If no defect is identified in the second scan, the location from 207 can be recorded as a location of a defect in the steel substrate. The method has therefore been used to determine whether there is a defect at a particular location in the x-y surface, and its approximate location in the z-direction (i.e. whether it is present in the composite repair material). Various additional steps to further characterise the defect can optionally be taken as indicated by the arrows 217 and described in more detail below.

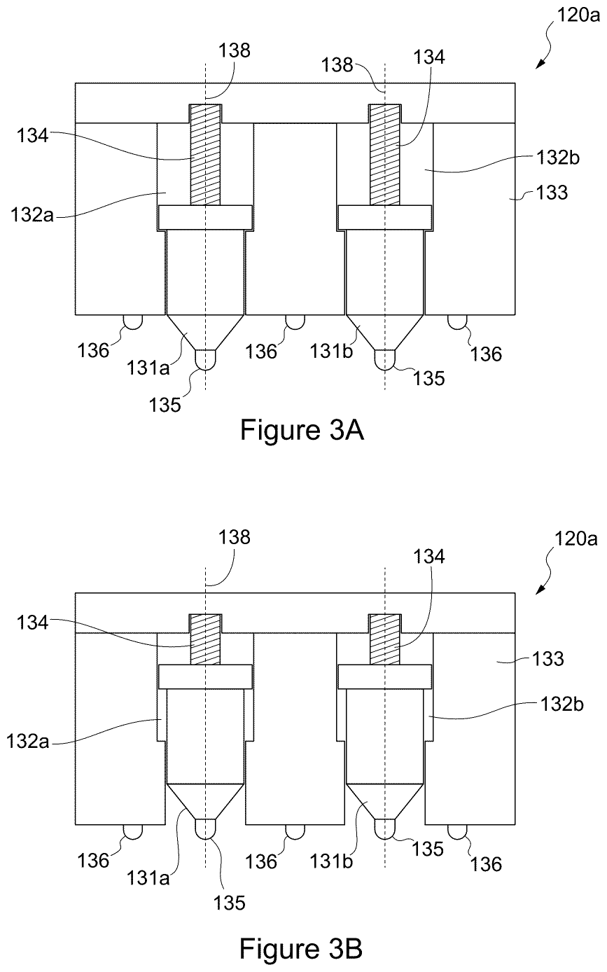

In the method 200, an approximate location of the defect can be determined by the steps 201 to 207 using a pitch and catch probe assembly 120a as described with reference to FIGS. 3A and 3B. The probe assembly 120a comprises a pair of transducer subassemblies 131a, 131b mounted in bores 132a, 132b in a probe housing 133. The transducer subassemblies 131 are movable in the bores 132 along their respective axes 138 between an extended outer position (FIG. 3A) and a retracted inner position (FIG. 3B), and are biased towards their outer positions by respective springs 134. The transducer subassemblies have contact tips 135, which are configured to be placed into contact with an inspection target to acoustically couple the transducer assemblies to the inspection target without use of coupling media such as gels or liquids. In use, an operator pushes the contact tips against the outer surface of the composite repair to at least partially retract the transducer subassemblies into the probe housing. Wear pins 136 provided on the surface of the housing prevent retraction of the subassemblies beyond a defined position and reduce damage to the housing and transducer subassemblies during use. The probe assembly 120a can be moved over the composite repair surface, and the biased axial movement of the subassemblies enables the contact tips 135 to ride over undulations and rough sections of the composite while still remaining in physical contact for acoustic coupling.

The force of the springs is selected to exert an appropriate force on the transducer subassemblies at the operative position (i.e. retracted to the point at which the wear pins contact the inspection material surface). A typical force component on each transducer subassembly is in the range of 0.4 N to 1.5 N, measured on an axis bisecting the angle between the transducer subassembly axes. As there are two subassemblies with respective springs, the force on the probe assembly in the range of 0.8 N to 3 N is required retract both transducer subassemblies to the operative position. In a particular embodiment, the force from each transducer subassembly on the inspection surface is approximately 0.9 N. Each spring may have a spring constant of approximately 0.2 N/mm (200 Nm⁻¹).

In the probe assembly 120a, the transducer subassemblies are mounted parallel to one another and in use are applied substantially perpendicularly to the surface of the composite in the repair zone. Such a probe set up provides a relatively wide field of view during the scan, which is useful for initial and approximate location of defects in the x-y directions. However, the spatial resolution of defect location in the x-y direction is compromised, and in particular embodiments of the invention, a novel probe assembly may be used for some of the inspection steps. Spacing between the contact tips 135 may be within a range of approximately 2 mm to 20 mm, and is selected depending on factors including the thickness of the composite repair layers, and the required sensitivity to near and/or far wall defects. A spacing approaching 2 mm will have increased sensitivity to defects at very near surface, while a spacing approaching 20 mm will cause a loss of near surface sensitivity but increase far wall sensitivity. A spacing of approximately 10 mm is typical.

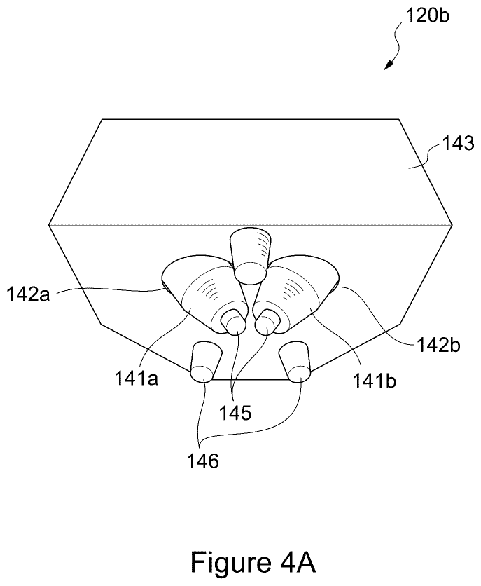

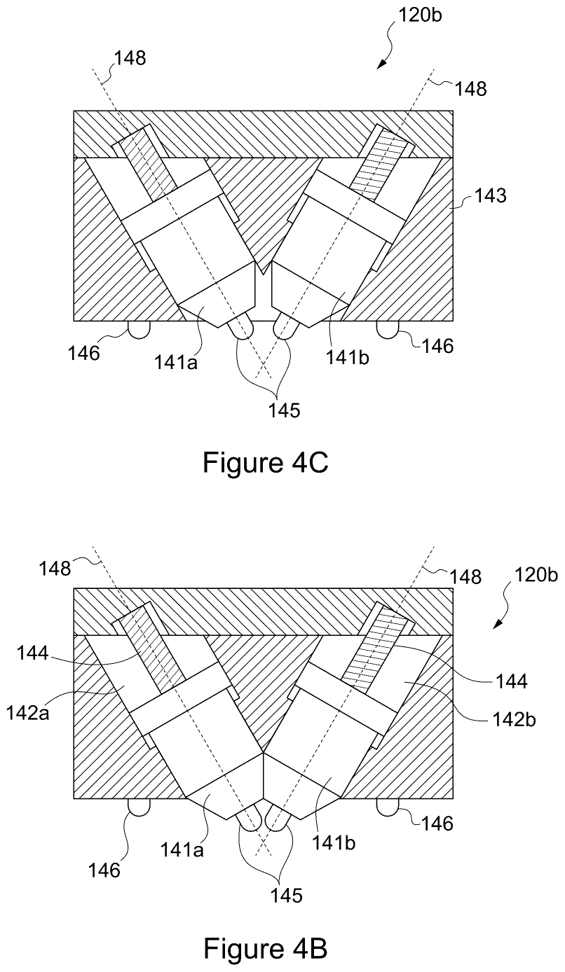

FIG. 4A is a perspective view of a probe assembly 120b according to an embodiment of the invention. FIGS. 4B and 4C are part-sectional views of the probe assembly 120b in extended and retracted conditions respectively. The probe assembly 120b is similar to probe assembly 120a, with like features indicated by like reference numerals incremented by 10. The probe assembly 120 b differs from the probe assembly 120a in that the orientation axes of the transducer subassemblies 141 are inclined to one another in a direction towards the contact tips 145. In use, an operator pushes the contact tips 145 against the outer surface of the composite repair to partially retract the transducer subassemblies into the bores 142a, 142b of probe housing 143 along the axes 148. Wear pins 146 limit retraction of the subassemblies to a defined position, shown in FIG. 4C. In this position, the contact tips of the transducer subassemblies are at a defined spacing from one another.

The probe assembly 120b can be moved over the composite repair surface, and the biased axial movement of the assemblies enables the contact tips 145 to ride over undulations and rough sections of the composite while still remaining in physical contact for acoustic coupling. The inclined axes of the subassemblies 142 means that the retraction forces acting on the subassemblies from the surface of the inspection target are not directed substantially along the direction of the bores and the subassembly axes, as they would typically be in the probe assembly 120a. To facilitate smooth movement of the transducer subassemblies in the bores, the housing 143 of this embodiment is formed from a low friction material. In this case, the housing is formed from a material which has sufficient wear characteristics, low friction properties, and does not resonate in the acoustic frequency ranges used in the inspection methods. An example category of such materials are self-lubricating composite materials comprising resin and polytetrafluoroethylene (PTFE), an example of which is the composite material marketed as TUFCOT® T200P by Tufcot Engineering Ltd. Other materials, including low friction and/or self-lubricating polymers or composites may be used in other embodiments of the invention. In alternative embodiments, rather than forming the housing from a low friction material, the transducer subassemblies and/or the wall of the bore may be formed from or coated with a low friction material to facilitate smooth movement of the transducer subassemblies in the housing.

The inventor has identified that certain geometries of probe assembly, and in particular the angle of the transducer subassembly transducer axes and the spacing between contact tips, are beneficial for improved acoustic inspection of composite repairs. In the embodiment of FIG. 4, the internal angle between the respective axes of the transmitter transducer and the receiver transducer is 60 degrees, and the wear pins 146 define a retracted position of the transducers with a spacing of 7 mm. This geometry has been found by the inventor to improve the spatial resolution of defects, in terms of position and sizing, in the x-y direction, compared with a configuration with parallel probe orientation as in probe assembly 120a. In addition, the geometry of the transducers in probe assembly 120b has been found to enable the detection of near surface defects in the composite material (i.e. those at shallow depths beneath the outer surface of the composite), that could not be detected with the probe assembly 120a. In particular, the probe assembly 120 b has successfully detected defects at depths as low as 0.8 mm below the outer surface of the composite, which is equivalent to approximately one layer of the composite wrap. In comparison to this, the minimum depth of defects detectable by conventional techniques is typically 25 mm below the outer surface of the composite. With respect to the x-y dimension of defects, the probe assembly 120b has successfully detected defects with a dimension of less than 20 mm, and even defects with an x-y dimension as low as approximately 15 mm.

Variations to the geometry of the probe assembly 120b have also been found to offer beneficial results in locating defects in the x-y direction, detecting defects with small dimensions in the x-y direction, and/or detection of near surface defects. Internal angles between the respective axes of the transmitter transducer and the receiver transducer in a range of 30 degrees to 90 degrees, and more preferably in the range of 45 degrees to 75 degrees, have been found to be advantageous. Contact tip spacings at the retracted position in the range of 3 mm to 11 mm, and more preferably in the range of 5 mm to 9 mm, have been found to be advantageous.

Although the probe assembly 120b is shown as having the transmitter transducer and the receiver transducer at approximately equal angles to a housing axis which in normal use is substantially perpendicular to a surface of the material to be inspected, alternative configurations are within the scope of the invention. For example, the transmitter transducer may be parallel to the housing axis, whilst the receiver transducer is at an angle to the housing axis. In a further alternative embodiment, the receiver transducer may instead be parallel to the housing axis, whilst the transmitter transducer is at an angle to the housing axis. In a further alternative embodiment, the transmitter and receiver transducer may be positioned such that they are each at a different angle to the housing axis.

As described above, inclined transducer axes have benefits in terms of sensitivity to defects, but offer a narrower field of view and therefore may not be suitable for initial scans of large surfaces. Accordingly, methods of embodiments of the invention may include multiple scans with different probe assemblies. For example, scans can be performed using a probe assembly 120a (i.e. with parallel transducer axes) to approximately locate defects in the x-y direction. Subsequent scans can be performed using a probe assembly with inclined transducer axes (e.g. probe assembly 120b) in particular locations in which defects have been approximately located using probe 120a.

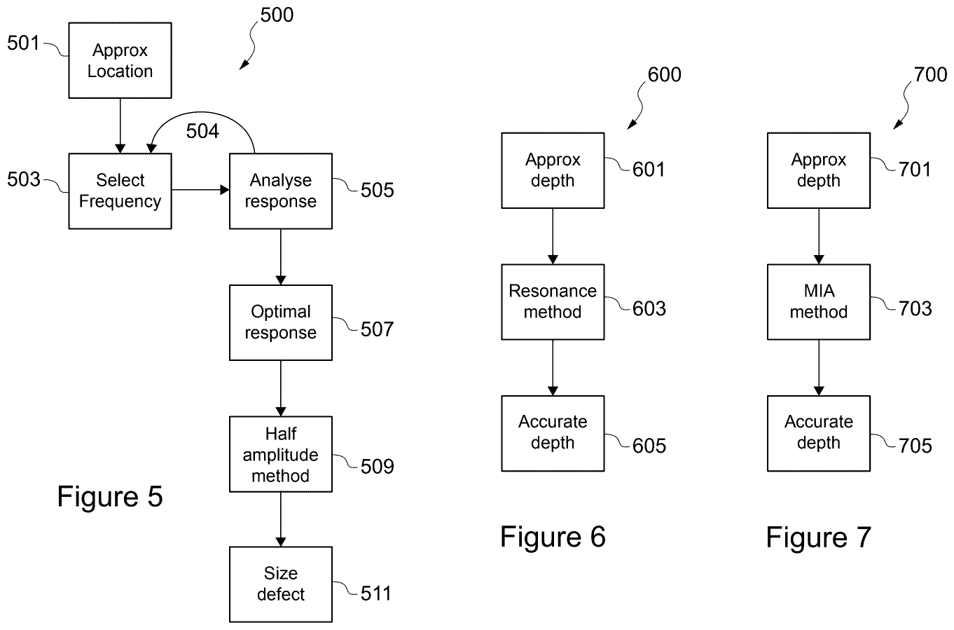

FIGS. 5 to 7 are schematic representations of additional method steps that may be used with the method 200 to enhance or improve the inspection results.

Referring to FIG. 5, there is shown generally at 500 a group of method steps that may be performed to determine the size of a defect in a composite repair. At step 501, an approximate location in an x-y direction has been determined using a broadband excitation and data analysis method as described with reference to FIG. 2, steps 201 to 207. Optionally, the steps 201 to 207 are repeated using a probe with inclined transducer axes (e.g probe assembly 120b) to more accurately determine the location of the defect. Having determined the location, the operator selects a particular frequency and inspects the defect (step 503), analysing the response (505). This is repeated (loop 504) for a number of different frequencies until the operator has determined an optimal frequency that maximises the response amplitude for the defect inspected (step 507). At this optimal frequency, a “half-amplitude” method is performed (509); the extremities of the half-amplitude signal in the x and y directions are recorded to characterise the size of the defect (step 511).

The steps 500 may be performed in addition to the steps of method 200, at any point after a defect has been approximately located or located in the composite repair zone.

Referring to FIG. 6, there is shown generally at 600 a group of method steps that may be performed to determine a depth (location in the z-direction) of a defect in a composite repair. At step 601, an approximate depth in the z-direction (i.e. whether the defect is in 1 the composite material) has been determined using the selective frequency excitation and data analysis method as described with reference to FIG. 2, steps 209 to 215. At step 603, the operator uses a resonance probe at a specific frequency and compares the signal and phase responses with signal and phase responses from reference samples at known depths. Correlation between the signal and phase responses of the composite repair and the reference sample enables the operator to characterise an accurate depth of the defect (i.e. its position in the composite material). In this regard, “accurate depth” is used only as a term relative to the “approximate depth” determination of steps 209 to 215 of method 200.

The steps 600 may be performed in addition to the steps of method 200, at any point after a defect has been identified in the composite material.

Referring to FIG. 7, there is shown generally at 700 a group of alternative method steps that may be performed to determine a depth (location in the z-direction) of a defect in a composite repair. The steps 700 may be performed instead of the method steps 600 of FIG. 6, for example if the resonance probe method does not identify a correlation with a reference sample, or may be used in conjunction with the steps 600 for example to provide verification.

At step 701, an approximate depth in the z-direction (i.e. whether the defect is in the composite material) has been determined using the selective frequency excitation and data analysis method as described with reference to FIG. 2, steps 209 to 215. At step 703, the operator uses a mechanical impedance analysis (MIA) probe at a specific frequency and compares the signal and phase responses with signal and phase responses from reference samples at known depths. Correlation between the signal and phase responses of the composite repair and the reference sample enables the operator to characterise an accurate depth of the defect (i.e. its position in the composite material).

The steps 700 may be performed in addition to the steps of method 200, at any point after a defect has been identified in the composite material.

Some or all of the groups of optional method steps 500, 600 and 700 may be performed in conjunction with the method 200, and the groups may be performed in different orders depending on operational requirements and convenience.

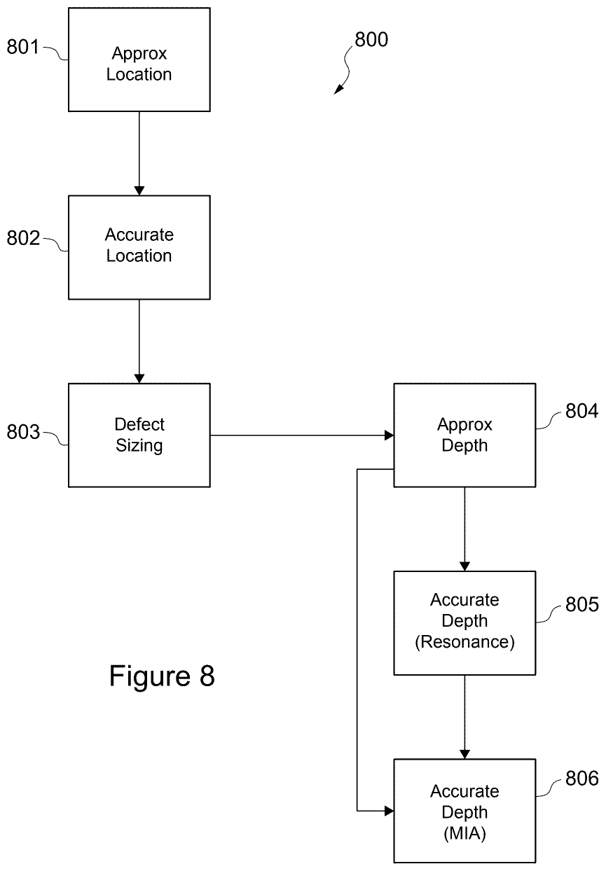

FIG. 8 is a schematic representation of a method of acoustically inspecting a composite repair according to a particular embodiment, in which the steps of the method 200 and optional steps of FIGS. 5 to 7 are performed in a particular sequence. In the method, generally depicted at 800, an approximate location of a defect in the x-y surface of the composite repair is determined by the method steps 201 to 207 of FIG. 2, using a probe assembly 120a with parallel transducer axes (step 801). At 802, method steps 201 to 207 of FIG. 2 are repeated with a probe assembly 120b, having inclined transducer axes, in order to more accurately determine the location of the defect in the x-y surface of the composite repair. The location being determined, the size of the defect is characterised (step 803) by the steps 500 of FIG. 5.

Step 804 determines an approximate depth of the defect (i.e. its location in the composite material) by the steps 209 to 215 of FIG. 2. A more accurate depth position is determined by the resonance probe (step 805) using method steps 600 of FIG. 6, and/or by the MIA probe (step 806) using method steps 700 of FIG. 7.

The invention provides a method and apparatus for acoustically inspecting a composite repair on a metal structure, the composite repair comprising at least one layer of a composite material applied to a metal substrate of the structure in a repair zone. The method comprises exciting the composite repair within the repair zone using a broadband acoustic excitation signal, and receiving and analysing acoustic data from the first acoustic scan to determine at least one approximate location of one or more defects in the repair zone. In a second acoustic scan, the composite repair is excited in the at least one approximate location using an acoustic excitation signal with frequency characteristics selected to excite the composite material in preference to the metal substrate, and receiving and analysing acoustic data from the second acoustic scan to enable the one or more defects to be characterised as being present in the least one layer of a composite material or present in the metal substrate. In an aspect of the invention, an acoustic probe assembly comprises a housing and first and second acoustic transducer subassemblies arranged in the housing. The first and second acoustic transducer subassemblies are configured to enable operation as a transmitter and a receiver respectively, and each of the transducer subassemblies is elongated along a respective axis of orientation, has a first end configured to contact against a material to be inspected, and is axially movable within a respective bore of the housing. The first ends of the first and second transducer subassemblies are biased towards an extended position in a direction towards the first ends; and the axes of the first and second transducers are inclined towards one another.

The invention in its described embodiments enables in-service inspection and monitoring of the structural integrity of composite repairs applied to structures, including vessels and pipelines. The apparatus and method have improved sensitivity to defects and flaws of small dimensions and an ability to be applied to a wide range of geometries. The techniques enable detection of defects that have a smaller dimension in a direction normal to the surface of the composite repair when compared with the prior art, which may be less than 0.1 mm and as low as approximately 0.05 mm. This facilitates detection of kissing bonds and/or intra-layer delaminations that have a much smaller dimension than those capable of being detected using conventional techniques. This is particularly important for in-service inspection methods, in which structures including vessels and/or pipelines being inspected may be at elevated temperatures, at which the apparent size of the defect may be reduced due to the thermal conditions. This may be of particular importance in the inspection of composite repairs on metal pipelines in the oil and gas sector, which are commonly used to carry fluids at elevated temperature.

Variations to the above-described embodiments fall within the scope of the invention as claimed.

1. A method of acoustically inspecting a composite repair on a metal structure, the composite repair comprising at least one layer of a composite material applied to a metal substrate of the structure in a repair zone, wherein the method comprises:
in a first acoustic scan, exciting the composite repair within the repair zone using a broadband acoustic excitation signal, and receiving and analysing acoustic data from the first acoustic scan to determine at least one approximate location of one or more defects in the repair zone; and
in a second acoustic scan, exciting the composite repair in the at least one approximate location using an acoustic excitation signal with frequency characteristics selected to excite the composite material in preference to the metal substrate, and receiving and analysing acoustic data from the second acoustic scan to enable the one or more defects to be characterised as being present in the least one layer of a composite material or present in the metal substrate.

2. (canceled)

3. The method according to claim 1, wherein the broadband acoustic excitation pulse comprises multiple frequencies in the range of 5 kHz to 50 kHz.

4. The method according to claim 1, wherein the second acoustic scan has an acoustic excitation signal with a frequency in the range of 15 kHz to 20 kHz.

5. The method according to claim 4, wherein the second acoustic scan has an acoustic excitation signal with a frequency of approximately 17 kHz.

6. The method according to claim 1, wherein the method comprises utilising an acoustic probe assembly comprising a transmitter transducer and a receiver transducer.

7. The method according to claim 6, wherein the method comprises utilising a pitch and catch acoustic method.

8.-10. (canceled)

11. The method according to claim 1, comprising detecting a defect that has a dimension in a direction normal to the surface of the composite repair of less than 0.5 mm.

12. (canceled)

13. (canceled)

14. The method according to claim 1, comprising carrying out an acoustic scan of the structure by manually manoeuvring the probe assembly in relation to the structure.

15. The method according to claim 1, wherein the structure is at an elevated temperature above an ambient temperature during the acoustic inspection.

16. The method according to claim 1, wherein the structure comprises a substrate of steel or a steel alloy, and the composite material forms at least a part of a composite repair applied to the substrate.

17. The method according to claim 1, wherein the structure comprises a pipeline, pipework or a pressure containing vessel.

18. An apparatus for acoustically inspecting a structure comprising a composite material, the apparatus comprising:
a probe assembly comprising a housing and first and second acoustic transducer subassemblies arranged in the housing;
wherein the first and second acoustic transducer subassemblies are configured to enable operation as a transmitter and a receiver respectively;
wherein each of the transducer subassemblies is elongated along a respective axis of orientation, has a first end configured to contact against a material to be inspected, and is axially movable within a respective bore of the housing;
wherein the first ends of the first and second transducer subassemblies are biased towards an extended position in a direction towards the first ends;
and wherein the axes of the first and second transducer subassemblies are inclined towards one another.

19. The apparatus according to any of claims 18, wherein the angle between the axes of the two transducer subassemblies may be in the range of 30 degrees to 90 degrees.

20. The apparatus according to claim 19, wherein the angle between the axes of the two transducer subassemblies is approximately 60 degrees.

21. The apparatus according to claim 18, wherein when the first and second transducer subassemblies are in their retracted positions, the distance between the first ends of the first and second transducer subassemblies is in the range of 5 mm to 9 mm.

22.-24. (canceled)

25. The apparatus according to claim 18, wherein two or more wear pins are provided on the probe housing.

26. The apparatus according to claim 25, wherein the wear pins provide a limit to the force that can be applied to the first ends of the first and second transducer subassemblies when contacting with the material to be inspected.

27. The apparatus according to claim 25 comprising a biasing means which biases the first and second transducer subassemblies towards an extended position, and wherein at the retracted position when the wear pins are in contact with the material to be inspected, the biasing means exerts a force on the respective transducer subassemblies in the range of 0.4 N to 1.5 N.

28. A method to acoustically inspect a structure comprising a composite material, the method comprising using the apparatus of claim 18.

29. The method according to claim 28, comprising carrying out an acoustic scan of the structure by manually manoeuvring the probe assembly in relation to the structure.

30. The method according to claim 28, wherein the structure is at an elevated temperature above an ambient temperature during the acoustic inspection.

31. The method according to claim 28, wherein the structure comprises a substrate of steel or a steel alloy, and the composite material forms at least a part of a composite repair applied to the substrate.

32. The method according to claim 28, wherein the structure comprises a pipeline, pipework or a pressure containing vessel.

33. (canceled)
